(19) United States
(12) Patent Application Publication
(10) Pub. No.: US 2026/0039349 A1
(43) Pub. Date: Feb. 5, 2026

(54) CHANNEL STATE INFORMATION SPATIAL DOMAIN PROFILE CONFIGURATION AND SELECTION FOR A PLURALITY OF TRANSMISSION RECEPTION POINTS

(71) Applicant: QUALCOMM Incorporated, San Diego, CA (US)

(72) Inventors: Jing DAI, Beijing (CN); Wei XI, Beijing (CN); Liangming WU, Beijing (CN); Hao XU, Beijing (CN)

(21) Appl. No.: 19/101,511

(22) PCT Filed: Sep. 20, 2022
(86) PCT No.: PCT/CN2022/119822

§ 371 Date: Feb. 5, 2025

(51) Int. Cl. H04B 7/06; H04W 72/0453; H04W 72/51; H04W 76/20

(52) U.S. Cl. CPC H04B 7/0626; H04W 72/0453; H04W 72/51; H04W 76/20

(57) ABSTRACT

A network node may transmit a channel state information (CSI) configuration including a set of spatial domain (SD) profiles associated with a plurality of SD basis quantities for each of a plurality of transmission reception points (TRPs). A user equipment (UE) may receive the CSI configuration including the set of SD profiles associated with the plurality of SD basis quantities for each of the plurality of TRPs. The UE may select an SD profile from the set of SD profiles associated with the plurality of SD basis quantities included in the CSI configuration. The UE may transmit, for the network node, CSI including the selected SD profile from the set of SD profiles associated with the plurality of SD basis quantities. The network node may receive the CSI including the selected SD profile from the set of SD profiles associated with the plurality of SD basis quantities.

### TECHNICAL FIELD

The present disclosure relates generally to communication systems, and more particularly, to channel state information (CSI) configuration for spatial domain (SD) selection for a plurality of transmission reception points (TRPs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment are provided. The apparatus may receive a channel state information (CSI) configuration including a set of spatial domain (SD) profiles associated with a plurality of SD basis quantities for each of a plurality of transmission reception points (TRPs). The apparatus may select an SD profile from the set of SD profiles associated with the plurality of SD basis quantities included in the CSI configuration. The apparatus may transmit, for a network node, CSI including the selected SD profile from the set of SD profiles associated with the plurality of SD basis quantities

In an aspect of the disclosure, a method, a computer-readable medium, and an apparatus at a network node are provided. The apparatus may transmit a channel state information (CSI) configuration including a set of spatial domain (SD) profiles associated with a plurality of SD basis quantities for each of a plurality of transmission reception points (TRPs). The apparatus may receive CSI including a selected SD profile from the set of SD profiles associated with the plurality of SD basis quantities. The CSI may be received from a user equipment (UE).

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE and a plurality of transmission reception points (TRPs) in an access network.

FIG. 5 is a diagram illustrating an example of a first portion and a second portion of a channel state information (CSI), in accordance with various aspects of the present disclosure.

FIG. 6 is a connection flow diagram illustrating an example of a UE configured to select a CSI profile from a CSI configuration transmitted by a network node, in accordance with various aspects of the present disclosure.

FIG. 7 is a flowchart of a method of wireless communication.

FIG. 8 is a flowchart of a method of wireless communication.

FIG. 9 is a diagram illustrating an example of a hardware implementation for an example apparatus and/or network entity.

FIG. 10 is a diagram illustrating an example of a hardware implementation for an example network entity.

FIG. 11 is a diagram illustrating an example of a hardware implementation for an example network entity.

### DETAILED DESCRIPTION

A network node may be configured to transmit data to a UE with coherent joint transmission (CJT) using multiple transmission reception points (mTRPs). A user equipment (UE) may be configured to select one or more spatial domain (SD) bases for the CJT. The selection of the one or more SD bases may be transmitted to the network node as channel state information (CSI). The overhead for selecting the one or more SD bases may be quite large for network systems that have many TRPs. An overhead that allows a UE to select any combination of SD bases from all TRPs in a network may also be wasteful. In addition, a network may be able to load-balance data transmissions better by limiting the SD bases that the UE may select from. To minimize the overhead used by a UE configuring a CJT using mTRP, for example to indicate a selection of an SD basis from a set of prospective SD bases, a network node may be configured to provide a CSI configuration to the UE having a reduced set of profiles that the UE may select. The UE may then select one or more profiles from the reduced set of profiles, and transmit an indication of the selection as CSI to the network node. The network node may use the CSI to configure a CJT.

A network node may transmit a CSI configuration including a set of SD profiles associated with a plurality of SD basis quantities for each of a plurality of transmission reception points (TRPs). A UE may receive the CSI configuration including the set of SD profiles associated with the plurality of SD basis quantities for each of the plurality of TRPs. The UE may select an SD profile from the set of SD profiles associated with the plurality of SD basis quantities included in the CSI configuration. The UE may transmit, for the network node, CSI including the selected SD profile from the set of SD profiles associated with the plurality of SD basis quantities. The network node may receive the CSI including the selected SD profile from the set of SD profiles associated with the plurality of SD basis quantities.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

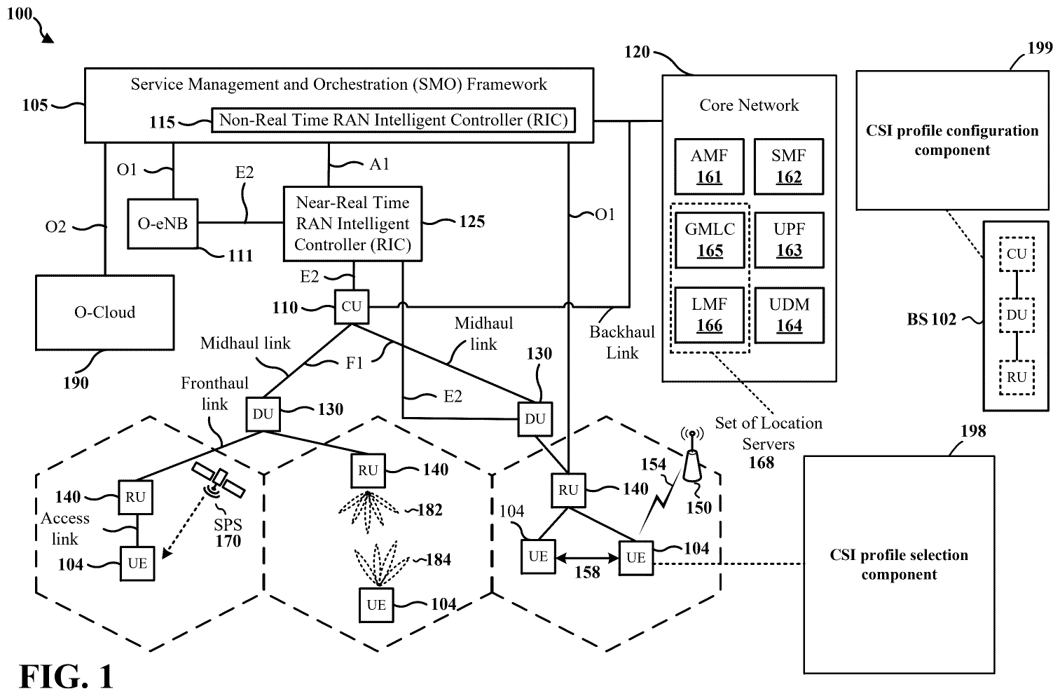

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a CSI profile selection component 198 configured to receive a CSI configuration including a set of SD profiles associated with a plurality of SD basis quantities for each of a plurality of TRPs. The CSI profile selection component 198 may be configured to select an SD profile from the set of SD profiles associated with the plurality of SD basis quantities included in the CSI configuration. The CSI profile selection component 198 may be configured to transmit, for a network node, CSI including the selected SD profile from the set of SD profiles associated with the plurality of SD basis quantities. In certain aspects, the base station 102 may have a CSI profile configuration component 199 configured to transmit a CSI configuration including a set of SD profiles associated with a plurality of SD basis quantities for each of a plurality of TRPs. The CSI profile configuration component 199 may be configured to receive CSI including a selected SD profile from the set of SD profiles associated with the plurality of SD basis quantities. The CSI may be received from a UE. Although the following description may be focused on coherent joint transmission (CJT) multi-TRP (mTRP), the concepts described herein may be applicable to other similar areas, such as sTRP or non-coherent joint transmission (NCJT). Although the following description may be focused on 5G NR, the concepts described herein may be applicable to other similar areas, such as LTE, LTE-A, CDMA, GSM, and other wireless technologies.

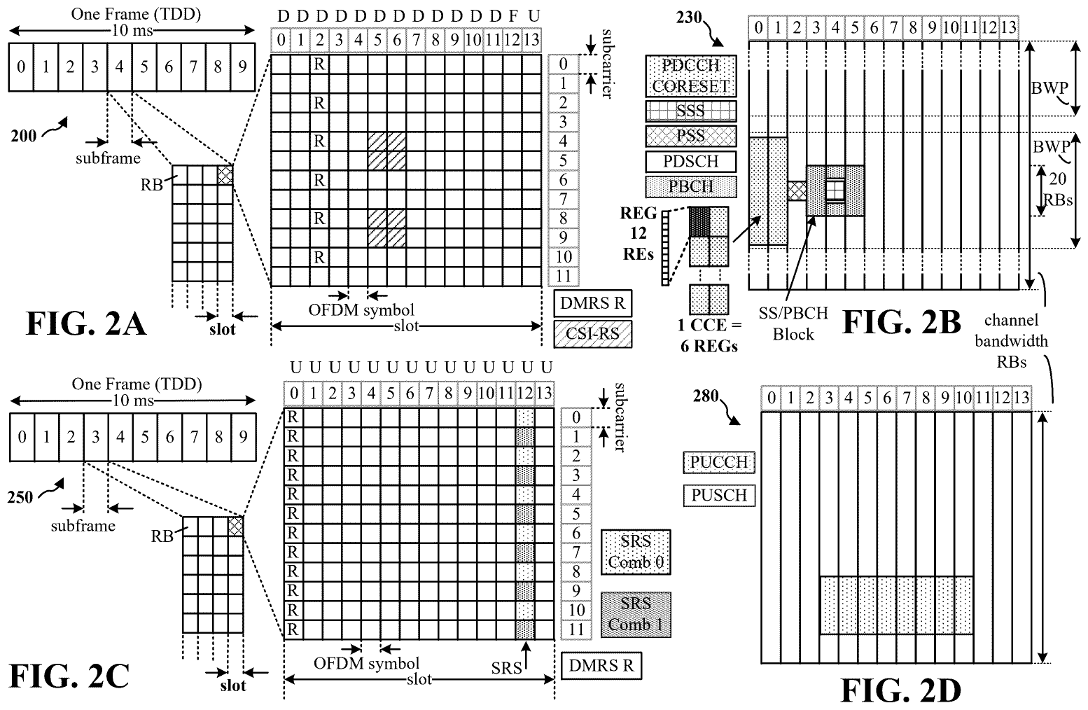

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

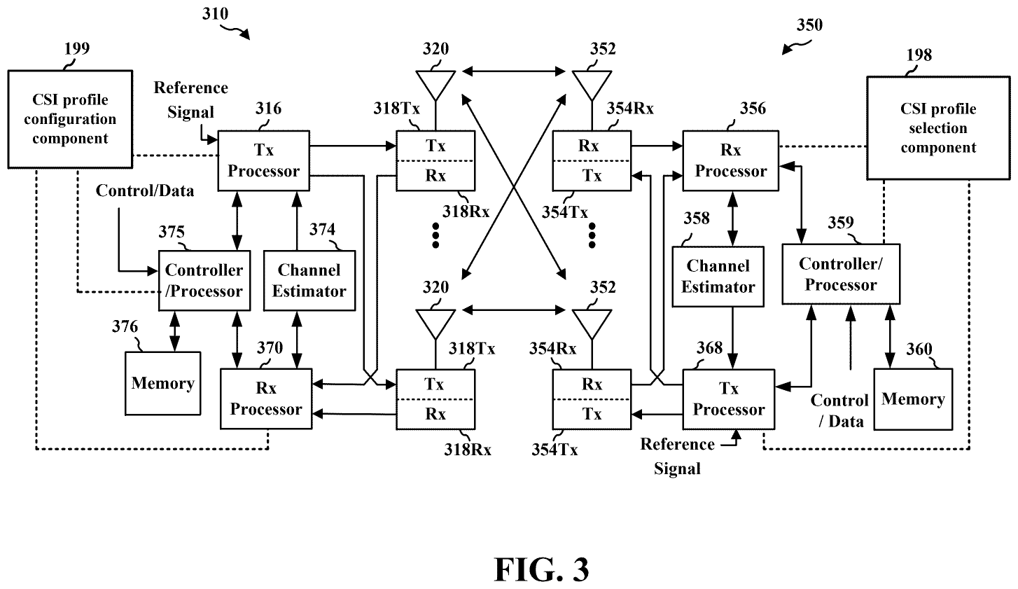

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal may include a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the CSI profile selection component 198 of FIG. 1.

At least one of the Tx processor 316, the Rx processor 370, and the controller/processor 375 may be configured to perform aspects in connection with the CSI profile configuration component 199 of FIG. 1.

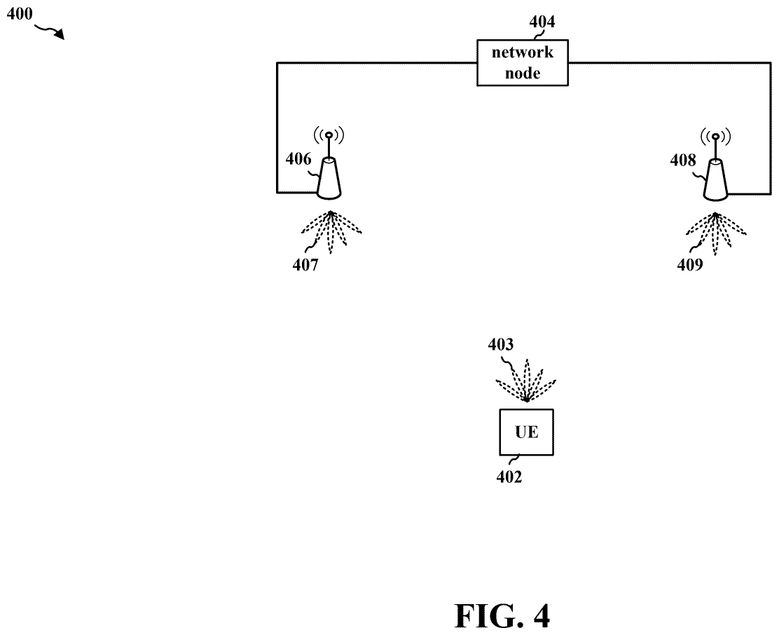

FIG. 4 is a diagram 400 illustrating an example of a UE 402 configured to transmit and receive data with a plurality of TRPs of a network, a TRP 406 and a TRP 408. The TRP 406 and the TRP 408 may be controlled by a common network node 404 that may use the TRP 406 and the TRP 408 to communicate with (transmit and receive data with) the UE 402. The TRP 406 and TRP 408 may be, for example, two different RUs having a common DU, two different RUs of two different DUs having a common CU, or two different RUs of two different DUs of two different CUs having a common core network. Each of the TRP 406 and TRP 408 may be panels, or may be individual TRPs. The TRP 406 may transmit signals 407 that may be received by the UE 402. The TRP 408 may transmit signals 409 that may be received by the UE 402. The UE may transmit signal 403 that may be received by the TRP 406 and/or the TRP 408. Diagram 400 illustrates an example of a UE 402 configured to communicate with a network node 404 using an mTRP access network. While the network node 404 is shown as communicating with the UE 402 with two TRPs, the network node 404 may communicate with the UE 402 using more than two TRPs in other aspects.

In some aspects, the network node 404 may transmit data to the UE 402 using a single TRP (sTRP), such as the TRP 406 or the TRP 408. However, the number of ports that sTRP may use to transmit data to the UE 402 may be limited. For example, the network node 404 may not be able to transmit data to the UE 402 using 32 ports via sTRP, since an antenna array with 32 ports may be too large for practical deployment. This is particularly the case with antenna arrays that use low-frequency bands. The network node 404 may transmit data to the UE 402 using multi-TRP (mTRP), for example by transmitting data simultaneously using the TRP 406 and the TRP 408, to increase the number of ports that the network node 404 may use. The network node 404 may be configured to transmit data to the UE 402 using mTRP in a plurality of ways.

In some aspects, the network node 404 may be configured to transmit data to the UE 402 in an mTRP network using a non-coherent joint transmission (NCJT). In other words, data transmitted from the network node 404 to the UE 402 may be pre-coded separately on the TRP 406 and the TRP 408. For example, if the TRP 406 may has an input X_{A} coded using a precoder V_{A}, and the TRP 408 has an input X_{B} coded using a precoder V_{B}, precoding for a transmission to the UE 402 may be represented by

$$[ \begin{matrix}{V}_{A} & 0 \\ 0 & {V}_{B}\end{matrix} ] [ \begin{matrix}{X}_{A} \\ {X}_{B}\end{matrix} ] = [ \begin{matrix}{V}_{A} {X}_{A} \\ {V}_{B} {X}_{B}\end{matrix} ] .$$

In the precoder calculation above, if TRP 406 has a rank indicator (RI) of one and TRP 408 has an RI of two, then the matrix Xₙ may have the dimensions (RI^{TRP}×1), where X_{A}: 1×1 and X_{B}: 2×1. Similarly, the matrix Vₙ may have the dimensions

$$( {N}_{t}^{T R P} \times {RI}^{T R P} ) ,$$

where V_{A}: 4×1 and V_{B}: 4×2. However, if the network node 404 uses NCJT to transmit data to the UE 402 via the TRP 406 and the TRP 408, the precoder for the TRP 406 and the precoder for the TRP 408 may not have any coherence between one another. Each of the precoders may be treated as different layers, each with its own rank.

In other aspects, the network node 404 may be configured to transmit data to the UE 402 in an mTRP network using a coherent joint transmission (CJT). In other words, data transmitted from the network node 404 to the UE 402 may be pre-coded jointly on the TRP 406 and the TRP 408. For example, if the TRP 406 has an input X_{A} coded using a precoder V_{A}, and the TRP 408 has an input X_{B} coded using a precoder V_{B}, precoding for a transmission to the UE 402 may be represented by

$$[ \begin{matrix}{V}_{A} \\ {V}_{B}\end{matrix} ] \times X = [ \begin{matrix}{V}_{A} X \\ {V}_{B} X\end{matrix} ] .$$

In the precoder calculation above, if TRP 406 has a rank indicator (RI) of one and TRP 408 has an RI of two, then the matrix X may have the dimensions

$$( {RI}_{max}^{T R P} \times 1 ) ,$$

where X: 2×1. Similarly, the matrix Vₙ may have the dimensions

$$( {N}_{t}^{T R P} \times {RI}_{max}^{T R P} ) ,$$

where V_{A}: 4×2 and V_{B}: 4×2. If the network node 404 uses CJT to transmit data to the UE 402 via the TRP 406 and the TRP 408, the precoder for the TRP 406 and the precoder for the TRP 408 may have phase coherence with one another. The UE 402 and the network node 404 may be configured to utilize CSI to configure CJT, enabling the network node 404 to use a larger number of ports across TRPs for CJT in low-frequency bands.

The network node 404 and the UE 402 may configure CJT using channel state information (CSI) transmitted from the UE 402 to the network node. For example, the UE 402 may use CSI to indicate a spatial domain (SD) basis (e.g., a selection of ports from a set of TRPs) or a frequency domain (FD) basis (e.g., a selection of frequencies from a set of bands or subbands) for a CJT using the TRP 406 and the TRP 408. In another example, where the network node 404 is connected to a set of TRPs, the UE 402 may select a combination of TRPs to transmit data to the UE 402, for example two TRPs of a set of eight possible TRPs.

In some aspects, the network node 404 may be in a state where it may not be ideal the UE 402 to freely select any combination of TRPs that may transmit data to the UE 402. For example, if the TRP 406 is dedicated to a high-bandwidth task for a period of time, the network node 404 may not want the UE 402 to select the TRP 406 for transmission to the UE 402. Moreover, CSI that indicates an SD basis for mTRP may have a larger reporting overhead than CSI that indicates an SD basis for sTRP. mTRP transmissions have more ports that may be used than sTRP transmissions, increasing the overhead to indicate a selection of ports for an mTRP CJT transmission. In addition, the number of possible combinations of SD bases that the UE 402 may select from for both the TRP 406 and the TRP 408 may be higher than the number of possible combinations of SD bases that the UE 402 may select from for the TRP 406 without the TRP 408, which may mean more bits to indicate a selection. To minimize the overhead used by the UE 402 to configure a CJT, for example to indicate a selection of an SD basis from a set of prospective SD bases, the network node 404 may be configured to provide a CSI configuration to the UE 402 having a reduced set of profiles that the UE 402 may select. The UE 402 may then select one or more profiles from the reduced set of profiles, and transmit an indication of the selection as CSI to the network node 404, which the network node 404 may then use to configure a CJT. The network node 404 may transmit a CSI configuration including a set of SD profiles associated with a plurality of SD basis quantities for each of a plurality TRPs. The UE 402 may receive the CSI configuration including the set of SD profiles associated with the plurality of SD basis quantities for each of the plurality of TRPs, such as TRP 406 and TRP 408. The UE 402 may select an SD profile from the set of SD profiles associated with the plurality of SD basis quantities included in the CSI configuration. The UE 402 may transmit, for the network node 404, CSI including the selected SD profile from the set of SD profiles associated with the plurality of SD basis quantities. The network node 404 may receive the CSI including the selected SD profile from the set of SD profiles associated with the plurality of SD basis quantities.

In one aspect, an eType-II precoder for one layer of one TRP (e.g., TRP 406 or TRP 408) may be represented by

$$W = {W}_{1} \times {\tilde{W}}_{2} \times {W}_{f}^{H} ,$$

where W₁ may represent an SD based selection (i.e., SD basis selection),

$${W}_{f}^{H}$$

may represent a Hermitian of an FD based selection (i.e., FD basis selection), and \tilde{W}₂ may represent a coefficient. For each layer, the precoder W may be an Nₜ×N₃ matrix, where N₃ may be a number of precoding matrix indicator (PMI) subbands and Nₜ may be a number of transmitting antennas. W₁ may be common among each layer, for up to four layers or RIs (e.g., each layer of a multi-layer precoder may have the same W₁ matrix). The SD basis W₁ may be selected from a set of discrete Fourier transform (DFT) bases, and may be an Nₜ×2L matrix, where Nₜ may be a number of transmitting antennas and L may be a number of beams. The FD basis W_{f} may be specific to a layer (e.g., each layer of a multi-layer precoder may have a different W_{f} matrix, although at least two layers may have a same W_{f} matrix). The coefficient \tilde{W}₂ may also be specific to a layer (e.g., each layer of a multi-layer precoder may have a different \tilde{W}₂ matrix, although at least two layers may have a same \tilde{W}₂ matrix). The possible SD bases from which W₁ is selected, the possible FD bases from which W_{f} is selected, the coefficients \tilde{W}₂, and/or the number of beams L may be configured by the network, such as the network node 404. Such a CSI configuration may be provided by RRC signaling. In some aspects, the UE 402 may select the SD basis W₁ from the possible SD bases and/or the FD basis W_{f} from the possible FD bases, or the network node 404 may configure the SD basis W₁ and the FD basis W_{f}.

In another aspect, a FD-joint precoder for one layer for each of the TRP 406 and the TRP 408 may be represented by

$$[ \begin{matrix}{W}^{TRP \# A} \\ {W}^{TRP \# B}\end{matrix} ] = [ \begin{matrix}{W}_{1 , A} & {\tilde{W}}_{2 , A} & {W}_{f}^{H} \\ {W}_{1 , B} & {\tilde{W}}_{2 , B} & {W}_{f}^{H}\end{matrix} ] = [ \begin{matrix}{W}_{1 , A} & 0 \\ 0 & {W}_{1 , B}\end{matrix} ] \times [ \begin{matrix}{\tilde{W}}_{2 , A} \\ {\tilde{W}}_{2 , B}\end{matrix} ] \times {W}_{f}^{H} .$$

In the precoder calculation above, W^{TRP #A} may represent a codebook structure for a layer of the TRP 406, and W^{TRP #B} may represent a codebook structure for a layer of the TRP 408. W_{1,A} may represent an SD basis selection for TRP 406, W_{1,B} may represent an SD basis selection for TRP 408,

$${W}_{f}^{H}$$

may represent a Hermitian of a joint FD basis selection for both TRP 406 and TRP 408, \tilde{W}_{2,A} may represent a coefficient for TRP 406, and \tilde{W}_{2,B} may represent a coefficient for TRP 408. The overall \tilde{W}₂ for the joint precoder may not be diagonal, as

$${\tilde{W}}_{2} = [ \begin{matrix}{\tilde{W}}_{2 , A} \\ {\tilde{W}}_{2 , B}\end{matrix} ] .$$

Such a precoder may be used for TRPs that are co-located, or intra-site. For example, TRP 406 and TRP 408 may be two panels that are co-located on a same mount. TRP 406 and TRP 408 may be panels of a multi-panel surface having a same orientation. TRP 406 and TRP 408 may be panels having different orientations, or inter-sector. Such a precoder may also be referred to as an FD-joint codebook for CJT. The possible SD bases from which W_{1,A} and/or W_{1,B} are selected, the possible FD bases from which We is selected, the coefficients \tilde{W}_{2,A}, \tilde{W}_{2,B}, and/or the number of beams L may be configured by the network, such as the network node 404. In some aspects, the UE 402 may select the SD basis W_{1,A} and/or W_{1,B} from the possible SD bases, may select the FD basis W_{f} from the possible FD bases, and/or may select the number of beams L for each of the TRP 406 and/or 408. In other aspects, the network node 404 may configure the SD basis W_{1,A}, the SD basis W_{1,B}, the FD basis W_{f}, and/or the number of beams L for each of the TRP 406 and/or 408.

In another aspect, an FD-independent precoder for one layer for each of the TRP 406 and the TRP 408 may be represented by

$$[ \begin{matrix}{W}^{TRP \# A} \\ {W}^{TRP \# B}\end{matrix} ] = [ \begin{matrix}{W}_{1 , A} & {\tilde{W}}_{2 , A} & {W}_{f , A}^{H} \\ {W}_{1 , B} & {\tilde{W}}_{2 , B} & {W}_{f , B}^{H}\end{matrix} ] = [ \begin{matrix}{W}_{1 , A} & 0 \\ 0 & {W}_{1 , B}\end{matrix} ] \times [ \begin{matrix}{\tilde{W}}_{2 , A} & 0 \\ 0 & q {\tilde{W}}_{2 , B}\end{matrix} ] \times [ \begin{matrix}{W}_{f , A}^{H} \\ {W}_{f , B}^{H}\end{matrix} ] .$$

In the example above, W^{TRP #A} may represent a codebook structure for a layer of the TRP 406, and W^{TRP #B} may represent a codebook structure for a layer of the TRP 408. W_{1,A} may represent an SD basis selection for TRP 406, W_{1,B} may represent an SD basis selection for TRP 408,

$${W}_{f , A}^{H}$$

may represent a Hermitian of an FD basis selection for TRP 406,

$${W}_{f , B}^{H}$$

may represent a Hermitian of an FD basis selection for TRP 408, \tilde{W}_{2,A} may represent a coefficient for TRP 406, \tilde{W}_{2,B} may represent a coefficient for TRP 408, and q may represent a co-phase or a co-amplitude coefficient. The overall \tilde{W}₂ for the joint precoder be diagonal, as

$${\tilde{W}}_{2} = [ \begin{matrix}{\tilde{W}}_{2 , A} & 0 \\ 0 & q {\tilde{W}}_{2 , B}\end{matrix} ] .$$

Such a precoder may be used for TRPs that are distributed, or inter-site. For example, TRP 406 and TRP 408 may be panels that are mounted to different structures, or may be antennas that are at least 20 meters apart. Such a precoder may also be referred to as an FD-independent codebook for CJT. The possible SD bases from which W_{1,A} and/or W_{1,B} are selected, the possible FD bases from which W_{f,A} and/or W_{f,B} are selected, the coefficients \tilde{W}_{2,A}, \tilde{W}_{2,B}, q and/or the number of beams L may be configured by the network, such as the network node 404. In some aspects, the UE 402 may select the SD basis W_{1,A} and/or W_{1,B} from the possible SD bases, may select the FD basis W_{f} from the possible FD bases, and/or may select the number of beams L for each of the TRP 406 and/or 408. In other aspects, the network node 404 may configure the SD basis W_{1,A}, the SD basis W_{1,B}, and the FD basis W_{f}, and/or the number of beams L for each of the TRP 406 and/or 408.

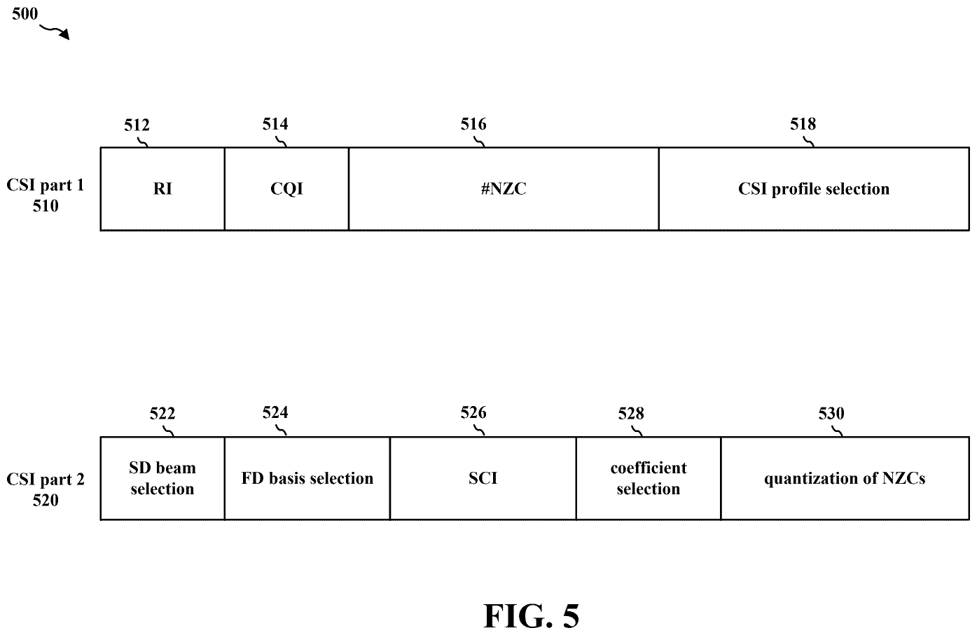

FIG. 5 is a diagram 500 illustrating an example of a first portion 510 and a second portion 520 of a CSI. The first portion 510 of the CSI may have a fixed size, or number of bits. A network node, such as the network node 404 in FIG. 4, that receives the first portion 510 of the CSI may decode the first portion 510 easily if the first portion 510 of the CSI has a fixed size. The first portion 510 of the CSI may have a rank indicator (RI) field 512 that indicates a rank of the CJT. The first portion 510 of the CSI may have a channel quality indicator (CQI) field 514 that indicates a CQI of the CJT. The first portion 510 of the CSI may have a non-zero coefficient (NZC) field 516 that may indicate a total number of NZC across all layers. The first portion 510 of the CSI may have a CSI profile selection field 518 that may indicate one or more CSI profiles that the CJT may use. A CSI profile may be, for example, an SD profile and/or an FD profile. Each SD profile may be associated with a plurality of SD basis quantities for each of a plurality of TRPs. Each FD profile may be associated with a plurality of FD basis quantities for each of a plurality of TRPs. The CSI profile selection field 518 may indicate a selection of an SD profile associated with a plurality of SD basis quantities for each of a plurality of TRPs that a network node, such as the network node 404 in FIG. 4, may use to transmit a CJT to a UE, such as the UE 402 in FIG. 4. The second portion 520 of the CSI may have a variable size, or a variable number of bits, based on the first portion 510 of the CSI. For example, a selection of a first CSI profile in the CSI profile selection field 518 may indicate a first size of the second portion 520 of the CSI, and a selection of a second CSI profile in the CSI profile selection field 518 may indicate a second size of the second portion 520 of the CSI. The second portion 520 of the CSI may have an SD beam selection field 522 that may indicate a selection of an SD basis. In other words, the SD beam selection field 522 may indicate the L beams out of N₁N₂O₁O₂ total beams for each TRP, where N₁ may be a number of columns for the ports of the TRP, N₂ may be a number of rows for the ports of the TRP, and O₁O₂ may represent an oversampling group for the TRP. In some aspects, N₁N₂=Nₜ, where Nₜ is the number of ports for the TRP. The size of the SD beam selection field 522 may vary based on the CSI profile selected in the CSI profile selection field 518 of the CSI profile selection field 518.

The second portion 520 of the CSI may have an FD basis selection field 524 that indicates a set of FD basis selected for a set of layers that corresponds with the CJT. The FD basis selection field 524 may indicate a selected FD basis for each layer of a set of layers ranging from 0 to RI-1, where RI is the rank indicator of the CJT. In other words, the FD basis selection field 524 may select M_{RI} bases for each layer out of N₃ bases, where RI indicates the rank of the layer, M represents an M-value for the FD codebook, and N₃ represents the total number of precoding matrices indicated by the PMI. The size of the FD basis selection field 524 may vary based on the CSI profile selected in the CSI profile selection field 518 in first portion 510 of the CSI. The second portion 520 of the CSI may have a strongest coefficient indication (SCI) field 526 that indicates a set of SCI for the set of layers that corresponds with the CJT. The SCI field 526 may indicate a selected SCI for each layer of a set of layers ranging from 0 to RI-1, where RI is the rank indicator of the CJT. In other words, the SCI field 526 may indicate a location of the strongest coefficients. The second portion 520 of the CSI may have a coefficient selection field 528 that indicates a location of NZCs within a \tilde{W}₂ for the set of layers that corresponds with the CJT. The coefficient selection field 528 may indicate a location of an NZC for each layer of a set of layers ranging from 0 to RI-1, where RI is the rank indicator of the CJT. In other words, the coefficient selection field 528 may indicate a location of NZCs within a \tilde{W}₂, or a \tilde{W}₂, l, where l indicates the layer of the TRP. The second portion 520 of the CSI may have a quantization of NZCs field 530 that indicates an amplitude and/or phase quantization for the set of layers that corresponds with the CJT. The quantization of NZCs field 530 may indicate an amplitude and/or phase quantization for each layer of a set of layers ranging from 0 to RI-1, where RI is the rank indicator of the CJT. In other words, the quantization of NZCs field 530 may indicate an amplitude and/or phase quantization of one or more NZCs.

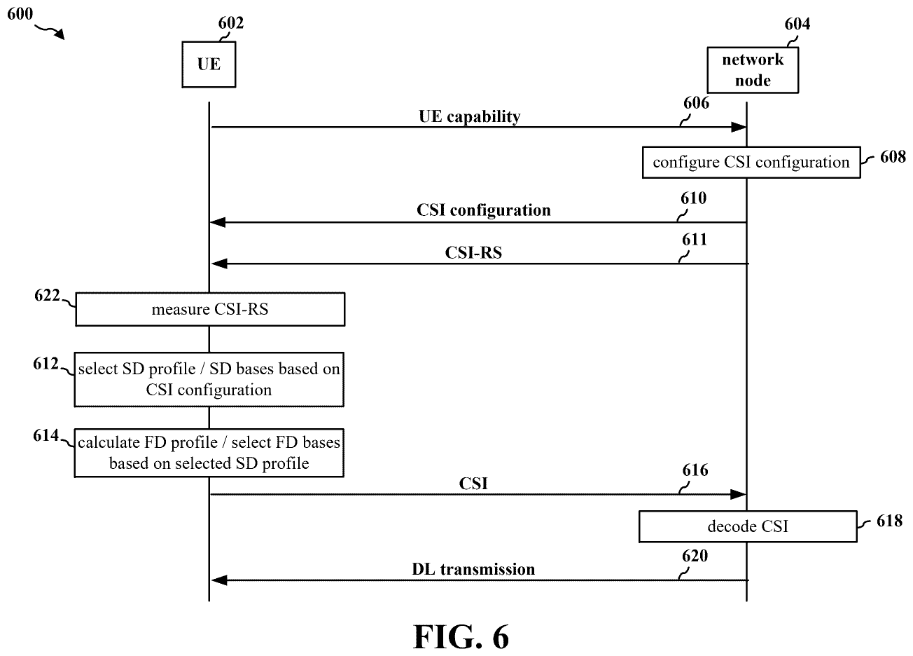

FIG. 6 is a connection flow diagram 600 illustrating an example of a UE 602 configured to select a CSI profile from a CSI configuration 610 transmitted by a network node 604.

The UE 602 may transmit a UE capability 606 to the network node 604. The network node 604 receive the UE capability 606 from the UE 602. The UE capability 606 may indicate a maximum configurable value of CSI profiles that the UE 602 may use to select a CSI profile. For example, the UE capability 606 may indicate that the UE 602 may select from a maximum of 32 SD profiles, or the UE capability 606 may indicate that the UE 602 may select from a maximum of 16 SD profiles. The UE capability of the maximum configurable value may be referred to as N_{profile}, where the selection may be indicated using log₂ N_{profile} bits. In other words, the number of bits of the CSI profile selection field 518 in FIG. 5 may be indicated by the value of N_{profile}.

At 608, the network node 604 may configure a CSI configuration 610 for the UE 602. The CSI configuration 610 may include a set of SD profiles associated with a plurality of SD basis quantities for each of a plurality of TRPs. For example, Table 1 below may be representative of a CSI configuration for a CJT having four TRPs.

TABLE 1

| SD profile ID | L₁ | L₂ | L₃ | L₄ |
|---|---|---|---|---|
| 0 | 2 | 2 | 2 | 2 |
| 1 | 4 | 2 | 2 | 0 |
| . . . | . . . | . . . | . . . | . . . |
| Max ID | 6 | 0 | 0 | 0 |

The configured SD profiles may include a number of selected SD bases for each TRP n, where n=1, 2, 3, and 4, for a total of four TRPs. In other words, if the UE 602 selects SD profile 0, TRP 1 may have two SD bases selected, TRP 2 may have two SD bases selected, TRP 3 may have two SD bases selected, and TRP 4 may have two SD bases selected. If the UE 602 selects SD profile 1, TRP 1 may have four SD bases selected, TRP 2 may have two SD bases selected, TRP 3 may have two SD bases selected, and TRP 4 may have zero SD bases selected. In other words, for SD profile 1, the UE 602 reports a TRP selection of TRP 1, 2 and 3 without TRP 4. In some aspects, each value of Lₙ may be greater than zero, allowing the UE 602 to select at least one SD basis quantity for each of the plurality of TRPs. This ensures that the UE 602 uses a network-configured combination of TRPs. In some aspects, the network node 604 may configure a total number of possible SD bases (Lₜₒₜ) for each SD profile in a CSI configuration to be the same. For example, the Lₜₒₜ for each SD profile may equal eight, allowing a UE to select a total of eight SD bases across all TRPs. In other aspects, the network node 604 may configure the Lₜₒₜ for each SD profile in a CSI configuration to be able to be different. For example, the Lₜₒₜ for the SD profile 1 in Table 1 is eight, and the Lₜₒₜ for the Max ID SD profile in Table 1 is six.

The CSI configuration 610 may also define one or more rules that the FD basis quantities may follow. The FD basis quantities may be determined based on the selected SD profile. The For example, the CSI configuration 610 may define that a total number of selected FD bases (Mₜₒₜ) may be the same for a different number of TRPs selected (e.g., Mₜₒₜ is the same for a first SD profile having three TRPs selected and a second SD profile having one TRP selected). The CSI configuration 610 may allow the UE 602 to determine Mₜₒₜ (for FD-independent codebooks), Mᵤₙᵢₒₙ (for FD-joint codebooks), and/or each Mₙ for each TRP selected by the UE, based on a first portion of the CSI 616, such as the first portion 510 of the CSI in FIG. 5.

In one aspect, for an FD-independent codebook, the CSI configuration 610 may define an Mₜₒₜ to be calculated as

$${M}_{tot} = {\sum }_{n = 1}^{N} {M}_{n} ,$$

where N may be the selected number of TRPs by the UE 602 and Mₙ may represent an FD basis quantity for a TRP n. N may be less than or equal to the total number of TRPs that the UE may select based on a table, such as Table 1. The CSI configuration 610 may indicate a configured nominal total M_{tot,nominal}, or reference value. M_{tot,nominal} may be less than or equal to Mₜₒₜ. In some aspects, the CSI configuration 610 may split the value of Mₙ equally for each TRP. For example,

$${M}_{n} = ⌊ \frac{{M}_{tot , nominal}}{N} ⌋ or ⌈ \frac{{M}_{tot , nominal}}{N} ⌉ .$$

In other aspects, the CSI configuration 610 may split the value of Mₙ proportionally to Lₙ. For example,

$${M}_{n} = ⌊ {M}_{tot , nominal} \frac{{L}_{n}}{{L}_{tot}} ⌋ or ⌈ {M}_{tot , nominal} \frac{{L}_{n}}{{L}_{tot}} ⌉ .$$

In other words, more beams may mean more delay paths.

In one aspect, for an FD-joint codebook, the CSI configuration 610 may define an Mᵤₙᵢₒₙ to be calculated as the number of FD bases in the union set by all sets of selected FD bases for all selected TRPs. In one aspect, the CSI configuration 610 may indicate a configured Mₙ that is equal for all TRPs, such that all selected TRPs have the same Mₙ value and all selected TRPs have the same selected FD bases. In other words, the value of N, which may be equal to the selected number of TRPs by the UE 602, may not affect the value of Mₙ, and Mₙ=Mᵤₙᵢₒₙ. An FD basis selection field, such as the FD basis selection field 524 in FIG. 5, may also be empty, as the UE 602 may not need to select any FD basis. In another aspect, the CSI configuration 610 may allow each TRP to have the same quantity of FD bases (e.g., each TRP has Mₙ=γMᵤₙᵢₒₙ FD bases, where 0<γ<1), and the UE may select a set of FD bases for each TRP. In another aspect, the CSI configuration 610 may set the value of Mₙ to be proportional to Lₙ. For example,

$${M}_{n} = ⌊ {M}_{tot , nominal} \frac{{L}_{n}}{{L}_{tot}} ⌋ or ⌈ {M}_{tot , nominal} \frac{{L}_{n}}{{L}_{tot}} ⌉ ,$$

where the CSI configuration 610 may indicate a configured nominal total M_{tot,nominal}, or reference value. In other words, more beams may mean more delay paths.

In some aspects, the CSI configuration 610 may include a table that defines a value for M_{tot,nominal} or Mᵤₙᵢₒₙ as a function of a set of M-value parameters. The UE 602 and/or the network node 604 may use the M-value parameters to calculate a value of M_{tot,nominal} or Mᵤₙᵢₒₙ to define an FD codebook, such as an FD-independent codebook or an FD-joint codebook. For example, Table 2 below may be representative of a CSI configuration for an M-value (e.g., M_{tot,nominal} or Mᵤₙᵢₒₙ) of an FD codebook.

TABLE 2

| M-value | | pᵥ where | pᵥ where | | |
|---|---|---|---|---|---|
| parameter ID | L | v ∈ {1, 2} | v ∈ {3, 4} | β | Restriction |
| 1 | 2 | 0.25 | 0.125 | 0.25 | |
| 2 | 2 | 0.25 | 0.125 | 0.5 | |
| 3 | 4 | 0.25 | 0.125 | 0.25 | |
| 4 | 4 | 0.25 | 0.125 | 0.5 | |
| 5 | 4 | 0.25 | 0.25 | 0.5 | |
| 6 | 4 | 0.25 | 0.25 | 0.75 | |
| 7 | 6 | 0.25 | — | 0.5 | RI = 1 or 2, |
| 8 | 6 | 0.25 | — | 0.75 | 32 ports, R = 1 |

For example, if the UE 602 receives the Table 2 above as the CSI configuration 610, an M-value (e.g., M_{tot,nominal} or Mᵤₙᵢₒₙ) may be calculated as

$$⌈ {p}_{v} \times \frac{{N}_{3}}{R} ⌉ ,$$

where the value of R may represent a number of PMI subbands per CQI subband, and N₃ may represent the total number of precoding matrices indicated by the PMI. N₃ may be based on the value of R. The value of R may be configured by the CSI configuration 610. In other words, the M-value may be calculated based on an RI value. M-values may be the same for a pair of ranks, for example the M-value for RI=1 or 2 may be the same, and the M-value for RI=3 or 4 may be the same.

The network node 604 may transmit the CSI configuration 610 to the UE 602. The UE 602 may receive the CSI configuration 610 from the network node 604. The CSI configuration 610 may be RRC configured. In other words, the network node 604 may transmit an RRC signal to the UE 602 that includes the CSI configuration 610.

The network node 604 may transmit at least one CSI-RS 611 to the UE 602. The UE 602 may receive the at least one CSI-RS 611 from the network node 604. At 622, the UE 602 may measure the at least one CSI-RS 611. The UE 602 may measure the at least one CSI-RS 611 based on the CSI configuration 610.

At 612, the UE 602 may select an SD profile and/or SD bases based on the CSI configuration 610 and the at least one CSI-RS 611. For example, the UE 602 may select an SD profile from a table similar to Table 1, which may determine how many SD bases the UE 602 may select from each TRP of a plurality of TRPs (i.e., an SD basis quantity). The UE 602 may also select an SD basis for each of the SD basis quantities associated with each of the plurality of TRPs. The selected SD profile may be indicated in a CSI profile selection field, such as the CSI profile selection field 518 in FIG. 5. The selected SD bases may be indicated in an SD beam selection field, such as the SD beam selection field 522 in FIG. 5.

At 614, the UE 602 may calculate an FD profile and/or select FD bases based on the CSI configuration 610. For example, the UE 602 may follow one of the aforementioned rules to calculate the value of Mₙ for each of the TRPs selected by the SD bases, which may determine how many FD bases the UE 602 may select from each TRP of a plurality of TRPs (i.e., an FD basis quantity). The UE 602 may select an FD basis based on the value of Mₙ for each of the TRPs of the plurality of TRPs.

The UE 602 may transmit the CSI 616 to the network node 604. The network node 604 may receive the CSI 616 from the UE 602.

At 618, the network node 604 may decode the CSI 616. The network node 604 may first decode a first portion of the CSI followed by the second portion of the CSI. The first portion of the CSI 616 may be a fixed size. The CSI 616 may include a selection of an SD profile from a set of SD profiles in the CSI configuration 610. The first portion of the CSI 616 may include the selection of the SD profile from the set of SD profiles in the CSI configuration 610. The size of a CSI profile selection field, such as the CSI profile selection field 518 in FIG. 5, may be based on a number of SD profiles in the CSI configuration 610. The size of the CSI profile selection field may be calculated as ┌log₂ N_{profile}┐, where N_{profile} is the number of SD profiles in the CSI configuration 610 (e.g., Max ID+1 with respect to Table 1 above). The first portion of the CSI may have an RI field, such as the RI field 512 in FIG. 5, that indicates a rank of the CJT. In some aspects, for an FD-independent codebook, the RI field may indicate a common rank for all TRPs. In other aspects, the RI field may indicate a plurality of ranks, one for each TRP. The UE 602 may be configured to maintain a same or similar total number of FD bases across all layers to provide similar report overhead. For example, a TRP with a higher rank may have a smaller value of Mₙ than another TRP with a lower rank. In other words, a TRP with a rank 1 may have a larger value of Mₙ and a TRP with a rank 2 may have a smaller value of Mₙ.

The size of the second portion of the CSI may be variable, based on one or more values in the first portion of the CSI, such as a selected SD profile from a set of SD profiles in the CSI configuration 610. The size of an SD selection field, such as the SD beam selection field 522 in FIG. 5, may be based on a number of beam oversampling groups (O₁O₂) and/or a number of selected SD bases (Lₙ) as compared with a number of ports for a TRP (N₁N₂). N₁ may be a number of columns for the ports of the TRP and N₂ may be a number of rows for the ports of the TRP such that N₁N₂=Nₜ, where Nₜ is the number of ports for the TRP. In some aspects, Nₜ may be the equal number of ports, per polarization, for each TRP. In one aspect, the size of the SD selection field may be calculated based on each Lₙ as to

$$⌈ {log}_{2} ( \begin{matrix}{N}_{1} {N}_{2} \\ {L}_{n}\end{matrix} ) ⌉ bits$$

select Lₙ SD bases out of a total number of N₁N₂ for each TRP from n=1 to N, where N is the total number of selected TRPs. In one aspect, the size of the SD selection field may be calculated based on an oversampling group selection as log₂ O₁O₂ bits for each TRP from n=1 to N, where N is the total number of selected TRPs.

The size of an FD basis selection field, such as the FD basis selection field 524 in FIG. 5, may be based on the total number of precoding matrices indicated by the PMI as compared with an M-value. In one aspect, for an FD-joint codebook, the size of the FD basis selection field may be calculated as

$$⌈ {log}_{2} ( \begin{matrix}{N}_{3} - 1 \\ {M}_{tot} - 1\end{matrix} ) ⌉ bits or ⌈ {log}_{2} ( \begin{matrix}{N}_{3} \\ {M}_{tot}\end{matrix} ) ⌉ bits$$

to select Mₜₒₜ or Mₜₒₜ−1 FD bases out of a total number of N₃ or N₃−1, respectively, for each layer, where N₃ may represent the total number of FD bases from a full set (which may also be the length of FD basis) and Mₜₒₜ may be calculated as

$${\sum }_{n = 1}^{N} {M}_{n} .$$

The value of Mₜₒₜ may us decremented by 1 to account for a selected FD basis indicated by an SCI field, such as the SCI field 526 in FIG. 5. In some aspects, the size of the FD basis selection field may be calculated as

$$⌈ {log}_{2} ( \begin{matrix}{N}_{3} - 1 \\ {M}_{tot} - 1\end{matrix} ) ⌉ bits or ⌈ {log}_{2} ( \begin{matrix}{N}_{3} \\ {M}_{tot}\end{matrix} ) ⌉ bits$$

for each layer where N₃≤19, and may be calculated based on a delay window with multi-stage selection (e.g., two-stage selection) where N₃>19.

In one aspect, for an FD-joint codebook or for an FD-independent codebook, the size of the FD basis selection field may be calculated as

$$⌈ {log}_{2} ( \begin{matrix}{N}_{3} - 1 \\ {M}_{n} - 1\end{matrix} ) ⌉ bits or ⌈ {log}_{2} ( \begin{matrix}{N}_{3} \\ {M}_{n}\end{matrix} ) ⌉ bits$$

to select Mₙ or Mₙ−1 FD bases out of a total number of N₃ or N₃−1, respectively, for each layer, where N₃ may represent the total number of precoding matrices indicated by the PMI and Mₙ may represent an FD basis quantity for a TRP n, where n may range from 1 to N number of selected TRPs. The value of N₃ and the value of Mₙ may be decremented by 1 to account for an FD basis indicated by an SCI field, such as the SCI field 526 in FIG. 5. In some aspects, the size of the FD basis selection field may be calculated as

$$⌈ {log}_{2} ( \begin{matrix}{N}_{3} - 1 \\ {M}_{n} - 1\end{matrix} ) ⌉ bits or ⌈ {log}_{2} ( \begin{matrix}{N}_{3} \\ {M}_{n}\end{matrix} ) ⌉ bits$$

for each layer where N₃≤19, and may be calculated based on a delay window with multi-stage selection (e.g., two-stage selection) where N₃>19. The location of delay window may be indicated by

$$⌈ {log}_{2} ( \begin{matrix}2 {M}_{n} - 1 \\ {M}_{n} - 1\end{matrix} ) ⌉ bits or ⌈ {log}_{2} ( \begin{matrix}2 {M}_{n} \\ {M}_{n}\end{matrix} ) ⌉ bits .$$

Since Mₙ may be different for different TRPs, the delay-window size may be different for different TRPs, as the delay-window size may be based on 2Mₙ.

The network node 604 may transmit at least one DL transmission 620 to the UE 602 based on the CSI 616. The UE 602 may receive the at least one DL transmission 620 from the network node 604 based on the CSI 616.

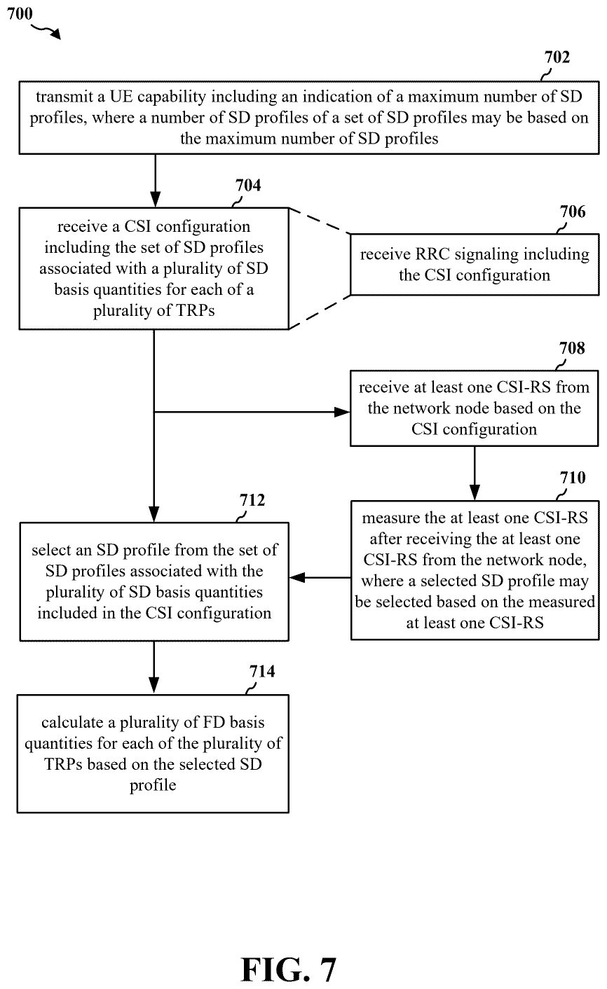

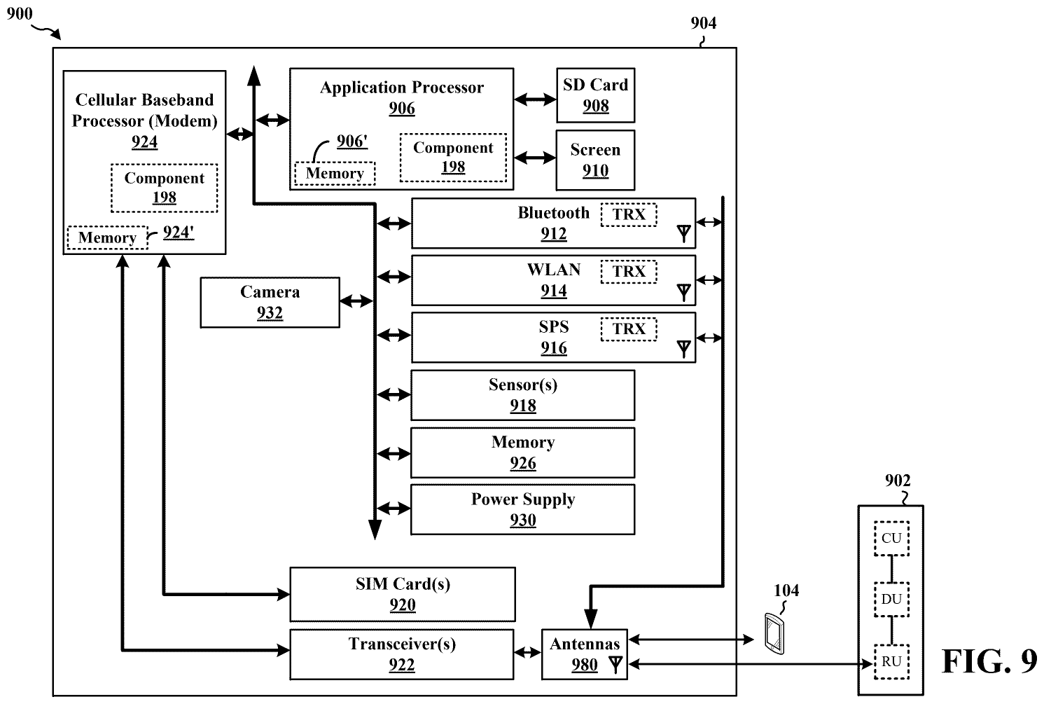

FIG. 7 is a flowchart 700 of a method of wireless communication. The method may be performed by a UE (e.g., the UE 104, the UE 350, the UE 402, the UE 602; the apparatus 904). At 702, the UE may transmit a UE capability including an indication of a maximum number of SD profiles. A number of SD profiles of a set of SD profiles may be based on the maximum number of SD profiles. For example, 702 may be performed by the UE 602 in FIG. 6, which may transmit a UE capability 606 to the network node 604. The UE capability 606 may include an indication of a maximum number of SD profiles that the UE 602 may handle. A number of SD profiles of a set of SD profiles, such as the number of SD profiles in the CSI configuration 610, may be based on the maximum number of SD profiles indicated by the UE capability 606. Moreover, 702 may be performed by the component 198 in FIG. 9.

At 704, the UE may receive a CSI configuration including the set of SD profiles associated with a plurality of SD basis quantities for each of a plurality of TRPs. For example, 704 may be performed by the UE 602 in FIG. 6, which may receive a CSI configuration 610 from the network node 604. The CSI configuration 610 may include the set of SD profiles associated with a plurality of SD basis quantities for each of a plurality of TRPs, such as Table 1 above. Moreover, 704 may be performed by the component 198 in FIG. 9.

At 706, the UE may receive RRC signaling including the CSI configuration. For example, 706 may be performed by the UE 602 in FIG. 6 may receive RRC signaling from the network node 604 that includes the CSI configuration 610. Moreover, 706 may be performed by the component 198 in FIG. 9.

At 708, the UE may receive at least one CSI-RS from the network node based on the CSI configuration. For example, 708 may be performed by the UE 602 in FIG. 6, which may receive at least one CSI-RS 611 from the network node 604 based on the CSI configuration 610. Moreover, 708 may be performed by the component 198 in FIG. 9.

At 710, the UE may measure the at least one CSI-RS after receiving the at least one CSI-RS from the network node. A selected SD profile may be selected based on the measured at least one CSI-RS. For example, 710 may be performed by the UE 602 in FIG. 6, which may, at 622, measure the at least one CSI-RS 611 after receiving the at least one CSI-RS 611 from the network node 604. At 612, the UE 602 may select an SD profile from the CSI configuration 610 based on the measured at least one CSI-RS 611. Moreover, 714 may be performed by the component 198 in FIG. 9.

At 712, the UE may select an SD profile from the set of SD profiles associated with the plurality of SD basis quantities included in the CSI configuration. For example, 712 may be performed by the UE 602 in FIG. 6, which may, at 612, select an SD profile from the set of SD profiles associated with the plurality of SD basis quantities included in the CSI configuration 610. Moreover, 712 may be performed by the component 198 in FIG. 9.

At 714, the UE may calculate a plurality of FD basis quantities for each of the plurality of TRPs based on the selected SD profile. For example, 714 may be performed by the UE 602 in FIG. 6, which may, at 614, calculate one or more FD basis quantities for each of the plurality of TRPs based on the SD profile selected at 612. Moreover, 714 may be performed by the component 198 in FIG. 9.

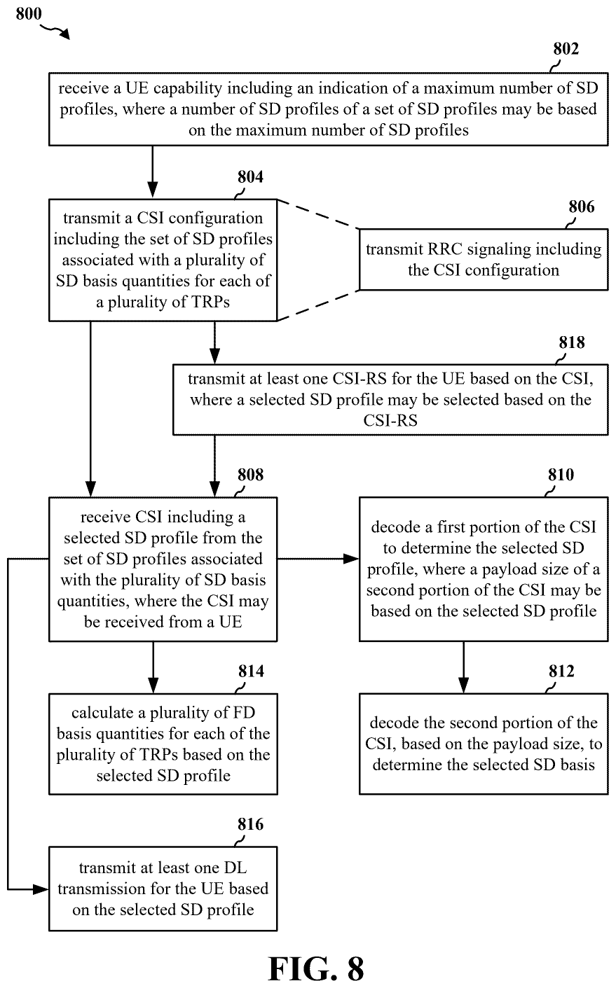

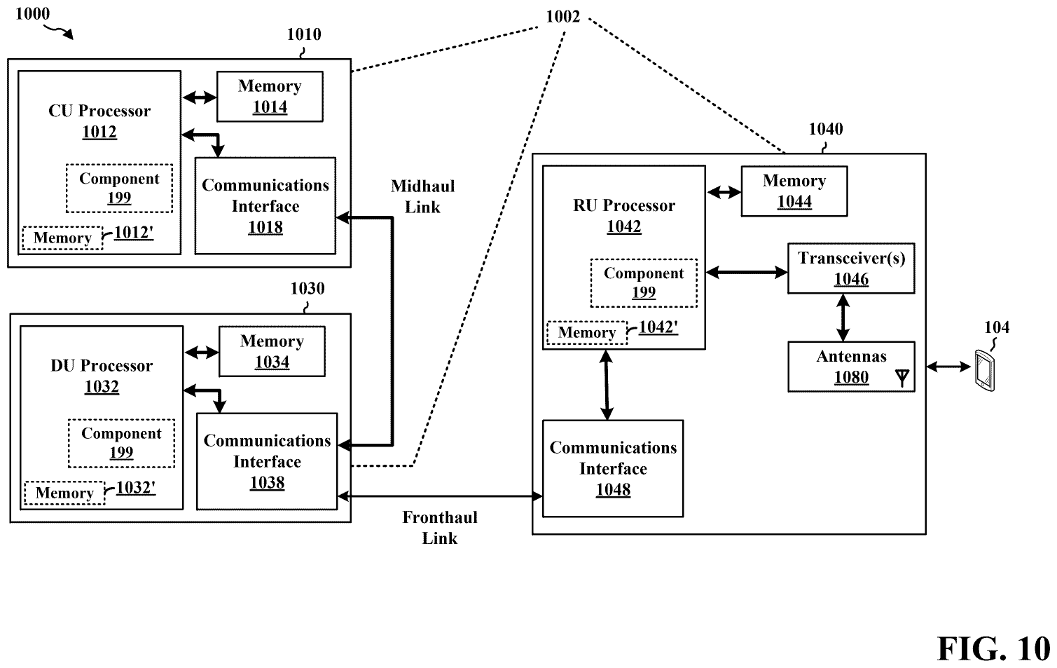

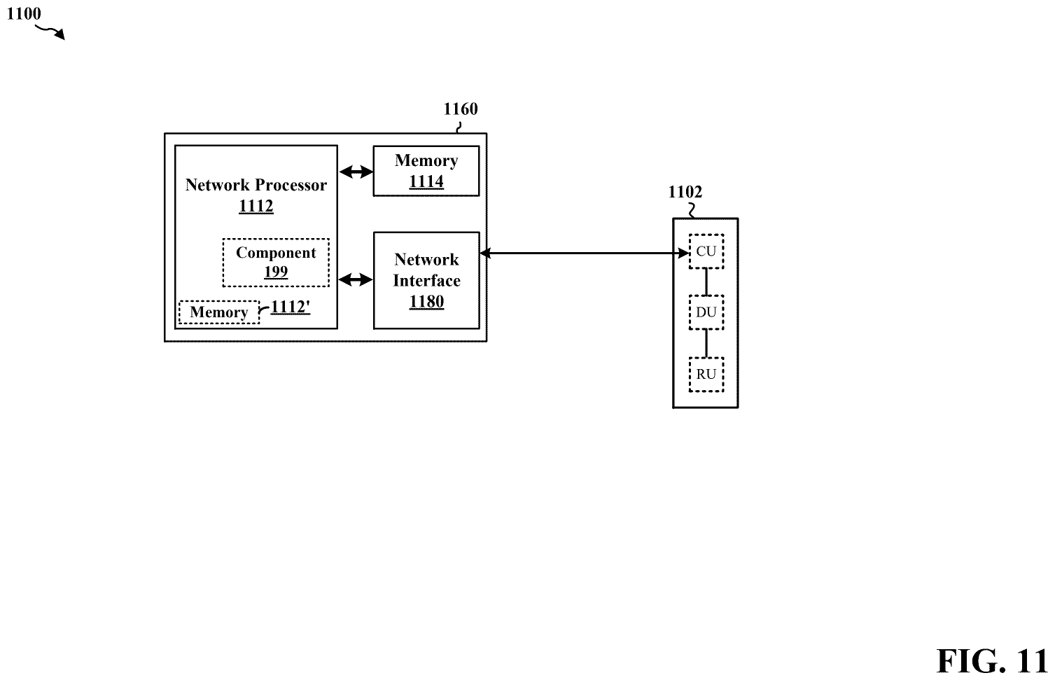

FIG. 8 is a flowchart 800 of a method of wireless communication. The method may be performed by a network node (e.g., the base station 102, the base station 310; the network node 404, the network node 604; the network entity 902, the network entity 1002, the network entity 1160). At 802, the network node may receive a UE capability including an indication of a maximum number of SD profiles. A number of SD profiles of a set of SD profiles may be based on the maximum number of SD profiles. For example, 802 may be performed by the network node 604 in FIG. 6, which may receive a UE capability 606 from the UE 602. The UE capability may include an indication of a maximum number of SD profiles that the UE 602 may handle. A number of SD profiles of a set of SD profiles may be based on the maximum number of SD profiles indicated in the UE capability 606. Moreover, 802 may be performed by the component 199 in FIG. 10 or 11.

At 804, the network node may transmit a CSI configuration including the set of SD profiles associated with a plurality of SD basis quantities for each of a plurality of TRPs. For example, 804 may be performed by the network node 604 in FIG. 6, which may transmit a CSI configuration 610 to the UE 602. The CSI configuration 610 may include the set of SD profiles associated with a plurality of SD basis quantities for each of a plurality of TRPs. Moreover, 804 may be performed by the component 199 in FIG. 10 or 11.

At 806, the network node may transmit RRC signaling including the CSI configuration. For example, 806 may be performed by the network node 604 in FIG. 6, which may transmit RRC signaling that includes the CSI configuration 610 to the UE 602. Moreover, 806 may be performed by the component 199 in FIG. 10 or 11.

At 818, the network node may transmit at least one CSI-RS for the UE based on the CSI configuration. A selected SD profile may be selected based on the CSI-RS. For example, 818 may be performed by the network node 604 in FIG. 6, which may transmit at least one CSI-RS 611 to the UE 602 based on the CSI configuration 610. At 612, the UE 602 may select an SD profile from the CSI configuration 610 based on the CSI-RS. Moreover, 818 may be performed by the component 199 in FIG. 10 or 11.

At 808, the network node may receive CSI including a selected SD profile from the set of SD profiles associated with the plurality of SD basis quantities. The CSI may be received from a UE. For example, 808 may be performed by the network node 604 in FIG. 6, which may receive CSI 616 from the UE 602. The CSI 616 may include the SD profile selected at 612 from the set of SD profiles associated with the plurality of SD basis quantities. Moreover, 808 may be performed by the component 199 in FIG. 10 or 11.

At 810, the network node may decode a first portion of the CSI to determine the selected SD profile. A payload size of a second portion of the CSI may be based on the selected SD profile. For example, 810 may be performed by the network node 604 in FIG. 6, which may, at 618, decode a first portion of the CSI 616 to determine the selected SD profile. The payload size of a second portion of the CSI 616 may be based on the selected SD profile. Moreover, 810 may be performed by the component 199 in FIG. 10 or 11.

At 812, the network node may decode the second portion of the CSI, based on the payload size, to determine the selected SD basis. For example, 812 may be performed by the network node 604 in FIG. 6, which may, at 618, decode the second portion of the CSI 616 based on the payload size. The second portion of the CSI 616 may include the selected SD basis. Moreover, 812 may be performed by the component 199 in FIG. 10 or 11.

At 814, the network node may calculate a plurality of FD basis quantities for each of the plurality of TRPs based on the selected SD profile. For example, 814 may be performed by the network node 604 in FIG. 6, which may, at 618, calculate a plurality of FD basis quantities for each of the plurality of TRPs based on the selected SD profile similar to the UE 602 at 614. Moreover, 814 may be performed by the component 199 in FIG. 10 or 11.

At 816, the network node may transmit at least one DL transmission for the UE based on the selected SD profile. For example, 816 may be performed by the network node 604 in FIG. 6, which may transmit at least one DL transmission 620 to the UE 602. The at least one DL transmission 620 may be transmitted based on the selected SD profile in the CSI 616. Moreover, 816 may be performed by the component 199 in FIG. 10 or 11.

FIG. 9 is a diagram 900 illustrating an example of a hardware implementation for an apparatus 904. The apparatus 904 may be a UE, a component of a UE, or may implement UE functionality. In some aspects, the apparatus 904 may include a cellular baseband processor 924 (also referred to as a modem) coupled to one or more transceivers 922 (e.g., cellular RF transceiver). The cellular baseband processor 924 may include on-chip memory 924′. In some aspects, the apparatus 904 may further include one or more subscriber identity modules (SIM) cards 920 and an application processor 906 coupled to a secure digital (SD) card 908 and a screen 910. The application processor 906 may include on-chip memory 906′. In some aspects, the apparatus 904 may further include a Bluetooth module 912, a WLAN module 914, an SPS module 916 (e.g., GNSS module), one or more sensor modules 918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 926, a power supply 930, and/or a camera 932. The Bluetooth module 912, the WLAN module 914, and the SPS module 916 may include an on-chip transceiver (TRX) (or in some cases, just a receiver). The Bluetooth module 912, the WLAN module 914, and the SPS module 916 may include their own dedicated antennas and/or utilize the antennas 980 for communication. The cellular baseband processor 924 communicates through the transceiver(s) 922 via one or more antennas 980 with the UE 104 and/or with an RU associated with a network entity 902. The cellular baseband processor 924 and the application processor 906 may each include a computer-readable medium/memory 924′, 906′, respectively. The additional memory modules 926 may also be considered a computer-readable medium/memory. Each computer-readable medium/memory 924′, 906′, 926 may be non-transitory. The cellular baseband processor 924 and the application processor 906 are each responsible for general processing, including the execution of software stored on the computer-readable medium/memory. The software, when executed by the cellular baseband processor 924/application processor 906, causes the cellular baseband processor 924/application processor 906 to perform the various functions described supra. The computer-readable medium/memory may also be used for storing data that is manipulated by the cellular baseband processor 924/application processor 906 when executing software. The cellular baseband processor 924/application processor 906 may be a component of the UE 350 and may include the memory 360 and/or at least one of the Tx processor 368, the Rx processor 356, and the controller/processor 359. In one configuration, the apparatus 904 may be a processor chip (modem and/or application) and include just the cellular baseband processor 924 and/or the application processor 906, and in another configuration, the apparatus 904 may be the entire UE (e.g., see UE 350 of FIG. 3) and include the additional modules of the apparatus 904.

As discussed supra, the component 198 is configured to receive a CSI configuration including a set of SD profiles associated with a plurality of SD basis quantities for each of a plurality of TRPs. The component 198 may be configured to select an SD profile from the set of SD profiles associated with the plurality of SD basis quantities included in the CSI configuration. The component 198 may be configured to transmit, for a network node, CSI including the selected SD profile from the set of SD profiles associated with the plurality of SD basis quantities. In certain aspects, the base station 102 may have a CSI profile configuration component 199 configured to transmit a CSI configuration including a set of SD profiles associated with a plurality of SD basis quantities for each of a plurality of TRPs. The component 198 may be within the cellular baseband processor 924, the application processor 906, or both the cellular baseband processor 924 and the application processor 906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 904 may include a variety of components configured for various functions. In one configuration, the apparatus 904, and in particular the cellular baseband processor 924 and/or the application processor 906, includes means for receiving a CSI configuration including a set of SD profiles associated with a plurality of SD basis quantities for each of a plurality of TRPs. The apparatus 904 may include means for selecting an SD profile from the set of SD profiles associated with the plurality of SD basis quantities included in the CSI configuration. The apparatus 904 may include means for transmitting, for a network node, CSI including the selected SD profile from the set of SD profiles associated with the plurality of SD basis quantities. The apparatus 904 may include means for receiving at least one CSI-RS from the network node based on the CSI. The apparatus 904 may include means for measuring the at least one CSI-RS after receiving the at least one CSI-RS from the network node. The apparatus 904 may include means for transmitting a UE capability including an indication of a maximum number of SD profiles. The apparatus 904 may include means for calculating a plurality of FD basis quantities for each of the plurality of TRPs based on the selected SD profile. The apparatus 904 may include means for receiving the CSI configuration by receiving RRC signaling including the CSI configuration. The means may be the component 198 of the apparatus 904 configured to perform the functions recited by the means. As described supra, the apparatus 904 may include the Tx processor 368, the Rx processor 356, and the controller/processor 359. As such, in one configuration, the means may be the Tx processor 368, the Rx processor 356, and/or the controller/processor 359 configured to perform the functions recited by the means.

FIG. 10 is a diagram 1000 illustrating an example of a hardware implementation for a network entity 1002. The network entity 1002 may be a BS, a component of a BS, or may implement BS functionality. The network entity 1002 may include at least one of a CU 1010, a DU 1030, or an RU 1040. For example, depending on the layer functionality handled by the component 199, the network entity 1002 may include the CU 1010; both the CU 1010 and the DU 1030; each of the CU 1010, the DU 1030, and the RU 1040; the DU 1030; both the DU 1030 and the RU 1040; or the RU 1040. The CU 1010 may include a CU processor 1012. The CU processor 1012 may include on-chip memory 1012′. In some aspects, the CU 1010 may further include additional memory modules 1014 and a communications interface 1018. The CU 1010 communicates with the DU 1030 through a midhaul link, such as an F1 interface. The DU 1030 may include a DU processor 1032. The DU processor 1032 may include on-chip memory 1032′. In some aspects, the DU 1030 may further include additional memory modules 1034 and a communications interface 1038. The DU 1030 communicates with the RU 1040 through a fronthaul link. The RU 1040 may include an RU processor 1042. The RU processor 1042 may include on-chip memory 1042′. In some aspects, the RU 1040 may further include additional memory modules 1044, one or more transceivers 1046, antennas 1080, and a communications interface 1048. The RU 1040 communicates with the UE 104. The on-chip memory 1012′, 1032′, 1042′ and the additional memory modules 1014, 1034, 1044 may each be considered a computer-readable medium/memory. Each computer-readable medium/memory may be non-transitory. Each of the processors 1012, 1032, 1042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit a CSI configuration including a set of SD profiles associated with a plurality of SD basis quantities for each of a plurality of TRPs. The component 199 may be configured to receive CSI including a selected SD profile from the set of SD profiles associated with the plurality of SD basis quantities. The CSI may be received from a UE. The component 199 may be within one or more processors of one or more of the CU 1010, DU 1030, and the RU 1040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1002 may include a variety of components configured for various functions. In one configuration, the network entity 1002 includes means for transmitting a CSI configuration including a set of SD profiles associated with a plurality of SD basis quantities for each of a plurality of TRPs. The network entity 1002 may include means for receiving CSI including a selected SD profile from the set of SD profiles associated with the plurality of SD basis quantities. The network entity 1002 may include means for transmitting the CSI configuration by transmitting RRC signaling including the CSI configuration. The network entity 1002 may include means for transmitting at least one CSI-RS for the UE based on the CSI configuration. The network entity 1002 may include means for receiving a UE capability including an indication of a maximum number of SD profiles. The network entity 1002 may include means for calculating a plurality of FD basis quantities for each of the plurality of TRPs based on the selected SD profile. The network entity 1002 may include means for decoding a first portion of the CSI to determine the selected SD profile. A payload size of a second portion of the CSI may be based on the selected SD profile. The network entity 1002 may include means for decoding the second portion of the CSI, based on the payload size, to determine the selected SD basis. The network entity 1002 may include means for transmitting at least one DL transmission for the UE based on the selected SD profile. The network entity 1002 may include means for transmitting the at least one DL transmission for the UE based on the selected SD profile by transmitting at least one CSI-RS for the UE based on the CSI. The means may be the component 199 of the network entity 1002 configured to perform the functions recited by the means. As described supra, the network entity 1002 may include the Tx processor 316, the Rx processor 370, and the controller/processor 375. As such, in one configuration, the means may be the Tx processor 316, the Rx processor 370, and/or the controller/processor 375 configured to perform the functions recited by the means.

FIG. 11 is a diagram 1100 illustrating an example of a hardware implementation for a network entity 1160. In one example, the network entity 1160 may be within the core network 120. The network entity 1160 may include a network processor 1112. The network processor 1112 may include on-chip memory 1112′. In some aspects, the network entity 1160 may further include additional memory modules 1114. The network entity 1160 communicates via the network interface 1180 directly (e.g., backhaul link) or indirectly (e.g., through a RIC) with the CU 1102. The on-chip memory 1112′ and the additional memory modules 1114 may each be considered a computer-readable medium/memory. Each computer-readable medium/memory may be non-transitory. The processor 1112 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit a CSI configuration including a set of SD profiles associated with a plurality of SD basis quantities for each of a plurality of TRPs. The component 199 may be configured to receive CSI including a selected SD profile from the set of SD profiles associated with the plurality of SD basis quantities. The CSI may be received from a UE. The component 199 may be within the processor 1112. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1160 may include a variety of components configured for various functions. In one configuration, the network entity 1160 includes means for transmitting a CSI configuration including a set of SD profiles associated with a plurality of SD basis quantities for each of a plurality of TRPs. The network entity 1160 may include means for receiving CSI including a selected SD profile from the set of SD profiles associated with the plurality of SD basis quantities. The network entity 1160 may include means for transmitting the CSI configuration by transmitting RRC signaling including the CSI configuration. The network entity 1160 may include means for transmitting at least one CSI-RS for the UE based on the CSI configuration. The network entity 1160 may include means for receiving a UE capability including an indication of a maximum number of SD profiles. The network entity 1160 may include means for calculating a plurality of FD basis quantities for each of the plurality of TRPs based on the selected SD profile. The network entity 1160 may include means for decoding a first portion of the CSI to determine the selected SD profile. A payload size of a second portion of the CSI may be based on the selected SD profile. The network entity 1160 may include means for decoding the second portion of the CSI, based on the payload size, to determine the selected SD basis. The network entity 1160 may include means for transmitting at least one DL transmission for the UE based on the selected SD profile. The network entity 1160 may include means for transmitting the at least one DL transmission for the UE based on the selected SD profile by transmitting at least one CSI-RS for the UE based on the CSI. The means may be the component 199 of the network entity 1160 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include receiving a CSI configuration including a set of SD profiles associated with a plurality of SD basis quantities for each of a plurality of TRPs. The method may include selecting an SD profile from the set of SD profiles associated with the plurality of SD basis quantities included in the CSI configuration. The method may include transmitting, for a network node, CSI including the selected SD profile from the set of SD profiles associated with the plurality of SD basis quantities.

Aspect 2 is the method of aspect 1, where at least one SD profile of the set of SD profiles may have an SD basis quantity equal to zero.

Aspect 3 is the method of any of aspects 1 and 2, where each of the plurality of SD basis quantities for each of the set of SD profiles may be greater than zero

Aspect 4 is the method of any of aspects 1 to 3, where receiving the CSI configuration may include receiving RRC signaling including the CSI configuration.

Aspect 5 is the method of any of aspects 1 to 4, where the method may include receiving at least one CSI-RS from the network node based on the CSI configuration. The method may include measuring the at least one CSI-RS after receiving the at least one CSI-RS from the network node. The selected SD profile may be selected based on the measured at least one CSI-RS.

Aspect 6 is the method of any of aspects 1 to 5, where the method may include transmitting a UE capability including an indication of a maximum number of SD profiles. A number of SD profiles of the set of SD profiles may be based on the maximum number of SD profiles.

Aspect 7 is the method of any of aspects 1 to 6, where the CSI may include a selection of an SD basis based on the selected SD profile.

Aspect 8 is the method of any of aspects 1 to 7, where the method may include calculating a plurality of FD basis quantities for each of the plurality of TRPs based on the selected SD profile.

Aspect 9 is the method of aspect 8, where the plurality of FD basis quantities may be based on an equal number of FD basis quantities for each of the plurality of TRPs.

Aspect 10 is the method of either of aspects 8 or 9, where the plurality of FD basis quantities is based on the plurality of SD basis quantities associated with the selected SD profile.

Aspect 11 is the method of either of aspects 8 or 10, where a first FD basis quantity associated with a first TRP of the plurality of TRPs may be different than a second FD basis quantity associated with a second TRP of the plurality of TRPs.

Aspect 12 is the method of aspect 11, where a first rank associated with the first TRP may be greater than a second rank associated with the second TRP. The first FD basis quantity may be lower than the second FD basis quantity.

Aspect 13 is the method of any of aspects 8 to 11, where a first delay window size associated with a first TRP of the plurality of TRPs may be different than a second delay window size associated with a second TRP of the plurality of TRPs.

Aspect 14 is a method of wireless communication at a network node, where the method may include transmitting a CSI configuration including a set of SD profiles associated with a plurality of SD basis quantities for each of a plurality of TRPs. The method may include receiving CSI including a selected SD profile from the set of SD profiles associated with the plurality of SD basis quantities. The CSI may be received from a UE.

Aspect 15 is the method of aspect 14, where at least one SD profile of the set of SD profiles may have an SD basis quantity equal to zero.

Aspect 16 is the method of any of aspects 14 and 15, where each of the plurality of SD basis quantities for each of the set of SD profiles may be greater than zero.

Aspect 17 is the method of any of aspects 14 to 16, where transmitting the CSI configuration may include transmitting RRC signaling including the CSI configuration.

Aspect 18 is the method of any of aspects 14 to 17, where the method may include transmitting at least one CSI-RS for the UE based on the CSI configuration.

Aspect 19 is the method of any of aspects 14 to 18, where the method may include receiving a UE capability including an indication of a maximum number of SD profiles. A number of SD profiles of the set of SD profiles may be based on the maximum number of SD profiles.

Aspect 20 is the method of any of aspects 14 to 19, where the method may include calculating a plurality of FD basis quantities for each of the plurality of TRPs based on the selected SD profile.

Aspect 21 is the method of aspect 20, where the plurality of FD basis quantities may be based on an equal number of FD basis quantities for each of the plurality of TRPs.

Aspect 22 is the method of either of aspects 20 or 21, where the plurality of FD basis quantities may be based on the plurality of SD basis quantities associated with the selected SD profile.

Aspect 23 is the method of either of aspects 20 or 21, where a first FD basis quantity associated with a first TRP of the plurality of TRPs is different than a second FD basis quantity associated with a second TRP of the plurality of TRPs.

Aspect 24 is the method of aspect 23, where a first rank associated with the first TRP may be greater than a second rank associated with the second TRP. The first FD basis quantity may be lower than the second FD basis quantity.

Aspect 25 is the method of any of aspects 20 to 24, where a first delay window size associated with a first TRP of the plurality of may be different than a second delay window size associated with a second TRP of the plurality of TRPs.

Aspect 26 is the method of any of aspects 14 to 25, where the CSI may include a selected SD basis based on the selected SD profile.

Aspect 27 is the method of any of aspects 14 to 26, where the method may include decoding a first portion of the CSI to determine the selected SD profile. A payload size of a second portion of the CSI may be based on the selected SD profile. The method may include decoding the second portion of the CSI, based on the payload size, to determine the selected SD basis.

Aspect 28 is the method of any of aspects 14 to 27, where the method may include transmitting at least one DL transmission for the UE based on the selected SD profile.

Aspect 29 is the method of any of aspects 14 to 27, where the method may include transmitting at least one CSI-RS for the UE based on the CSI configuration. The selected SD profile may be selected based on the CSI-RS.

Aspect 30 is an apparatus for wireless communication, including: a memory; and at least one processor coupled to the memory and, based at least in part on information stored in the memory, the at least one processor is configured to implement any of aspects 1 to 29.

Aspect 31 is the apparatus of aspect 30, further including at least one of an antenna or a transceiver coupled to the at least one processor.

Aspect 32 is an apparatus for wireless communication including means for implementing any of aspects 1 to 29.

Aspect 33 is a computer-readable medium (e.g., a non-transitory computer-readable medium) storing computer executable code, where the code when executed by a processor causes the processor to implement any of aspects 1 to 29.

1. An apparatus for wireless communication at a user equipment (UE), comprising:
a memory; and
at least one processor coupled to the memory and, based at least in part on information stored in the memory, the at least one processor is configured to:
receive a channel state information (CSI) configuration including a set of spatial domain (SD) profiles associated with a plurality of SD basis quantities for each of a plurality of transmission reception points (TRPs);
select an SD profile from the set of SD profiles associated with the plurality of SD basis quantities included in the CSI configuration; and
transmit, for a network node, CSI comprising the selected SD profile from the set of SD profiles associated with the plurality of SD basis quantities.

2-3. (canceled)

4. The apparatus of claim 1, further comprising a transceiver coupled to the at least one processor, wherein, to receive the CSI configuration, the at least one processor is configured to:
receive, via the transceiver, radio resource control (RRC) signaling comprising the CSI configuration.

5. The apparatus of claim 1, wherein the at least one processor is further configured to:
receive at least one CSI reference signal (CSI-RS) from the network node based on the CSI configuration; and
measure the at least one CSI-RS after receiving the at least one CSI-RS from the network node, wherein the selected SD profile is selected based on the measured at least one CSI-RS.

6. The apparatus of claim 1, wherein the at least one processor is further configured to:
transmit a UE capability comprising an indication of a maximum number of SD profiles, wherein a number of SD profiles of the set of SD profiles is based on the maximum number of SD profiles.

7. (canceled)

8. The apparatus of claim 1, wherein the at least one processor is further configured to:
calculate a plurality of frequency domain (FD) basis quantities for each of the plurality of TRPs based on the selected SD profile.

9-10. (canceled)

11. The apparatus of claim 8, wherein a first FD basis quantity associated with a first TRP of the plurality of TRPs is different than a second FD basis quantity associated with a second TRP of the plurality of TRPs.

12. The apparatus of claim 11, wherein a first rank associated with the first TRP is greater than a second rank associated with the second TRP, wherein the first FD basis quantity is lower than the second FD basis quantity.

13. The apparatus of claim 8, wherein a first delay window size associated with a first TRP of the plurality of TRPs is different than a second delay window size associated with a second TRP of the plurality of TRPs.

14. An apparatus for wireless communication at a network node, comprising:
a memory; and
at least one processor coupled to the memory and, based at least in part on information stored in the memory, the at least one processor is configured to:
transmit a channel state information (CSI) configuration including a set of spatial domain (SD) profiles associated with a plurality of SD basis quantities for each of a plurality of transmission reception points (TRPs); and
receive CSI comprising a selected SD profile from the set of SD profiles associated with the plurality of SD basis quantities, wherein the CSI is received from a user equipment (UE).

15-16. (canceled)

17. The apparatus of claim 14, further comprising a transceiver coupled to the at least one processor, wherein, to transmit the CSI configuration, the at least one processor is configured to:
transmit, via the transceiver, radio resource control (RRC) signaling comprising the CSI configuration.

18. The apparatus of claim 14, wherein the at least one processor is further configured to:
receive a UE capability comprising an indication of a maximum number of SD profiles, wherein a number of SD profiles of the set of SD profiles is based on the maximum number of SD profiles.

19. The apparatus of claim 14, wherein the at least one processor is further configured to:
calculate a plurality of frequency domain (FD) basis quantities for each of the plurality of TRPs based on the selected SD profile.

20-21. (canceled)

22. The apparatus of claim 19, wherein a first FD basis quantity associated with a first TRP of the plurality of TRPs is different than a second FD basis quantity associated with a second TRP of the plurality of TRPs.

23. The apparatus of claim 22, wherein a first rank associated with the first TRP is greater than a second rank associated with the second TRP, wherein the first FD basis quantity is lower than the second FD basis quantity.

24. The apparatus of claim 19, wherein a first delay window size associated with a first TRP of the plurality of TRPs is different than a second delay window size associated with a second TRP of the plurality of TRPs.

25. The apparatus of claim 14, wherein the CSI comprises a selected SD basis based on the selected SD profile.

26. The apparatus of claim 25, wherein the at least one processor is further configured to:
decode a first portion of the CSI to determine the selected SD profile, wherein a payload size of a second portion of the CSI is based on the selected SD profile; and
decode the second portion of the CSI, based on the payload size, to determine the selected SD basis.

27. (canceled)

28. The apparatus of claim 14, wherein the at least one processor is further configured to:
transmit at least one CSI reference signal (CSI-RS) for the UE based on the CSI configuration, wherein the selected SD profile is selected based on the CSI-RS.

29. A method of wireless communication at a user equipment (UE), comprising:
receiving a channel state information (CSI) configuration including a set of spatial domain (SD) profiles associated with a plurality of SD basis quantities for each of a plurality of transmission reception points (TRPs);
selecting an SD profile from the set of SD profiles associated with the plurality of SD basis quantities included in the CSI configuration; and
transmitting, for a network node, CSI comprising the selected SD profile from the set of SD profiles associated with the plurality of SD basis quantities.

30. A method of wireless communication at a network node, comprising:
transmitting a channel state information (CSI) configuration including a set of spatial domain (SD) profiles associated with a plurality of SD basis quantities for each of a plurality of transmission reception points (TRPs); and
receiving CSI comprising a selected SD profile from the set of SD profiles associated with the plurality of SD basis quantities, wherein the CSI is received from a user equipment (UE).
